(19) United States
(12) Patent Application Publication
(10) Pub. No.: US 2008/0162259 A1
(43) Pub. Date: Jul. 3, 2008

(54) ASSOCIATED COMMUNITY PLATFORM

(75) Inventors: Dhanurjay Patil, Belmont, CA (US); Matthew Mengerink, San Jose, CA (US); Timothy M. Murphy, San Mateo, CA (US); Palash Nandy, San Francisco, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC.

(21) Appl. No.: 11/618,465

(22) Filed: Dec. 29, 2006

(51) Int. Cl. G06F 17/30; G06F 15/173; G06F 15/18; G06F 9/30

(52) U.S. Cl. 705/10; 706/12; 709/203; 712/221

(57) ABSTRACT

Embodiments of an associated community platform are shown. Some embodiments comprise a receiver residing on a server to receive data from one or more nodes that are apart of a merchant network, a calculator residing on the server to calculate a score based upon the data, a mapper residing on the server to map the score to an assessment score, and a alerter residing on a server to alert where a threshold value is exceed by the mapping of the score to the assessment score. Additionally, a method embodiment is illustrated comprising receiving data from one or more nodes that are apart of a merchant network, calculating a score based upon the data, mapping the score to an assessment score, and alerting where a threshold value is exceed by the mapping of the score to the assessment score. Algorithms may be implemented to determine the existence of links in network.

### TECHNICAL FIELD

The present application relates generally to the technical field of data mining applications and, in one specific example, the use of data mining to track network behavior.

### BACKGROUND

Communications between individuals in a network based community often reflect the shared values of that community. These values may be the desire, wants, goals and other values of the community that makes up the network. For example, an interest in purchasing certain goods and services may be reflected in the communication between these individuals, or even an interest in engaging in illicit activities.

### BRIEF DESCRIPTION OF THE DRAWINGS

Some embodiments are illustrated by way of example and not limitation in the figures of the accompanying drawings in which:

FIG. 1 is a global map illustrating various fraudsters and their location.

FIG. 2 is a diagram illustrating an example network of fraudster.

FIG. 3 is a diagram illustrating an example network including normal actors and fraudsters.

FIG. 4 is a diagram illustrating and example network describing the connection of two sub networks (e.g., a fraudster sub network and a normal actor sub network) over a bridge.

FIG. 5 is a diagram illustrating an example social network.

FIG. 6 is a diagram illustrating an example network describing a hypothetical link between a fraudster and normal actor.

FIG. 7 is a diagram illustrating an example network describing an example link query made by, for example, an e-commerce site.

FIG. 8 is a network diagram illustrating a link determination between the normal actor and the fraudster based upon a list of attributes.

FIG. 9 is a flowchart showing an example method to record and generate global scores.

FIG. 10 is a flowchart illustrating an example method to record and generate attribute data.

FIG. 11 is a block diagram illustrating an example system to determine network relationships.

FIG. 12 is a flowchart illustrating an example method to implement a linking module.

FIG. 13 is a flowchart illustrating an example method used to implement a linking module for real time data.

FIG. 14 is a flowchart illustrating an example method to implement a global scoring module using composite scoring.

FIG. 15 is a flowchart illustrating an example method to implement a global scoring module using a feed system of scoring.

FIG. 16 is a flowchart illustrating an example method use to implement a global attribute abbreviation module.

FIG. 17 is a flowchart illustrating an example method used to implement a global attribute abbreviation module used for updating or generating new OLAP attribute mapping entries.

FIG. 18 is a diagram illustrating an example social network describing services used by a particular individual as generated by an attribute abbreviation module.

FIG. 19 is a network diagram illustrating the updating of an existing database and network diagram contained therein.

FIG. 20 is a flowchart illustrating example method used to implement a comparison module for determining the network that a member is apart of.

FIG. 21 is a flowchart illustrating an example method used to implement a module for Artificial Intelligence (AI) based assessment scores for global attributes.

FIG. 22 is a flowchart illustrating an example method used to implement module for AI based assessment scores for global conduct scores.

FIG. 23 is a network diagram illustrating and example bayesian network depicting the hypothetical bases for a marketing good or services to a member of a social network.

FIG. 24 shows a diagrammatic representation of a machine in the example form of a computer system.

### DETAILED DESCRIPTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

In some embodiments, various data mining techniques are utilized to make predictions about the behavior of individuals who are apart of one or more social networks. Data mining is used to engage in the extraction of nontrivial implicit, previously unknown and potentially useful information. Many times this data is derived from a large data set, and it processed using one of many types of AI based algorithms. These algorithms may include a bayesian decision theory algorithm, a maximum likelihood and bayesian estimation algorithm, an algorithm implementing a nonparametric technique, a linear discrimination function or algorithm, a multilayer neural networks algorithm, a stochastic methods or algorithm, a nonmetric method or algorithm, an algorithm-independent machine learning algorithm, an unsupervised learning and clustering algorithm or some other suitable algorithm. In some cases one or more layers of analysis implementing one or more of these AI algorithms in combination with one another may be implemented. For example, a genetic algorithm may be used in combination with an Simulated Annealing (SA) algorithm such that the SA algorithm optimizes the results set of the genetic algorithm.

These AI algorithms are often times implemented in combination with certain database applications that are able to process large amounts of data, and provide a multidimensional analysis of the data such that associations between certain pieces of data may be understood over a long period of time. One common application that provides for multidimensional analysis is an On Line Analytic Processing (OLAP) application. A characteristic of OLAP is the ability to aggregate data into a view and can then be observed by a user of an OLAP system. In some cases, one or more of the various AI algorithms may be used to generate a view of the data. These views may reflect, for example, a network of fraud, or a network of individuals with a share interest in certain goods or services.

### Fraud and Marketing Networks

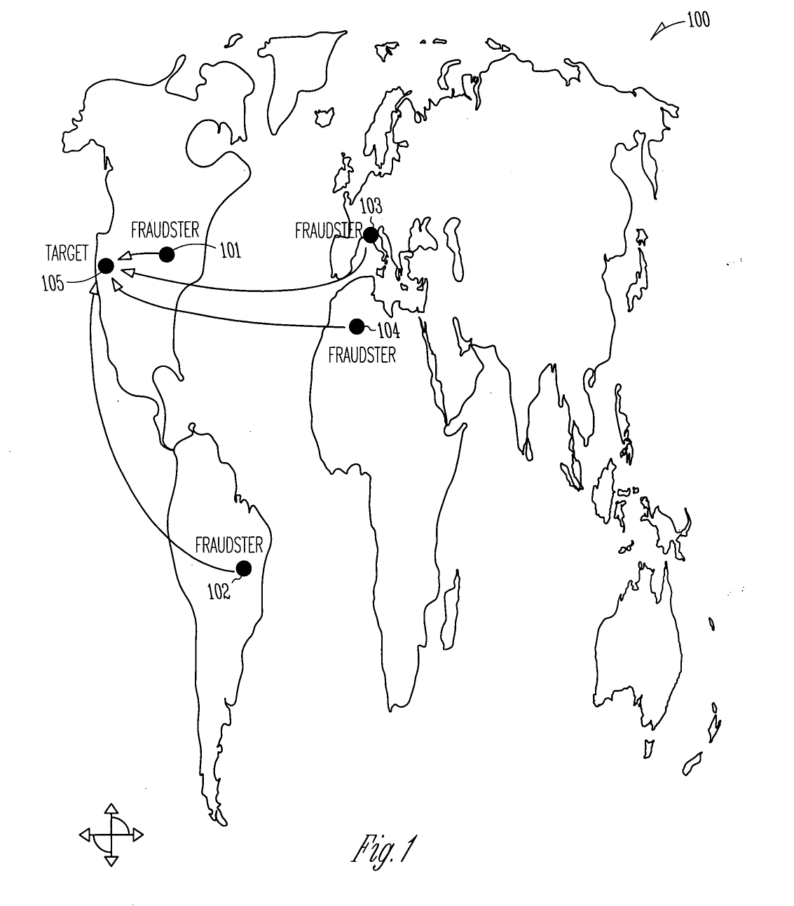

FIG. 1 is a global map 100, illustrating various fraudsters and their location. Illustrated is a fraudster 101 residing in the United States, a fraudster 103 residing in Europe, a fraudster 104 residing in Africa, and a fraudster 102 residing in South America. Also described is a target 105 of these fraudsters (e.g., 101, 102, 103, and 104) and the location of the target 105 which in this case is the United States. These fraudsters and their fraudulent activities, in some cases, may be coordinated using various technological tools such as cell phones, emails, and other means of communication. Additionally, certain types of connected account, or business account information may be utilized to further their fraudulent scheme. This may include, for example, debit or credit card accounts or some other type of financial account. For example, the various fraudsters may all attempt to impersonate the same account holder of a debit or credit card and all attempt to transact business at the same time. In some cases, the fact that the actual geographical location of the fraudster cannot be known helps the fraudsters facilitate this fraudulent scheme.

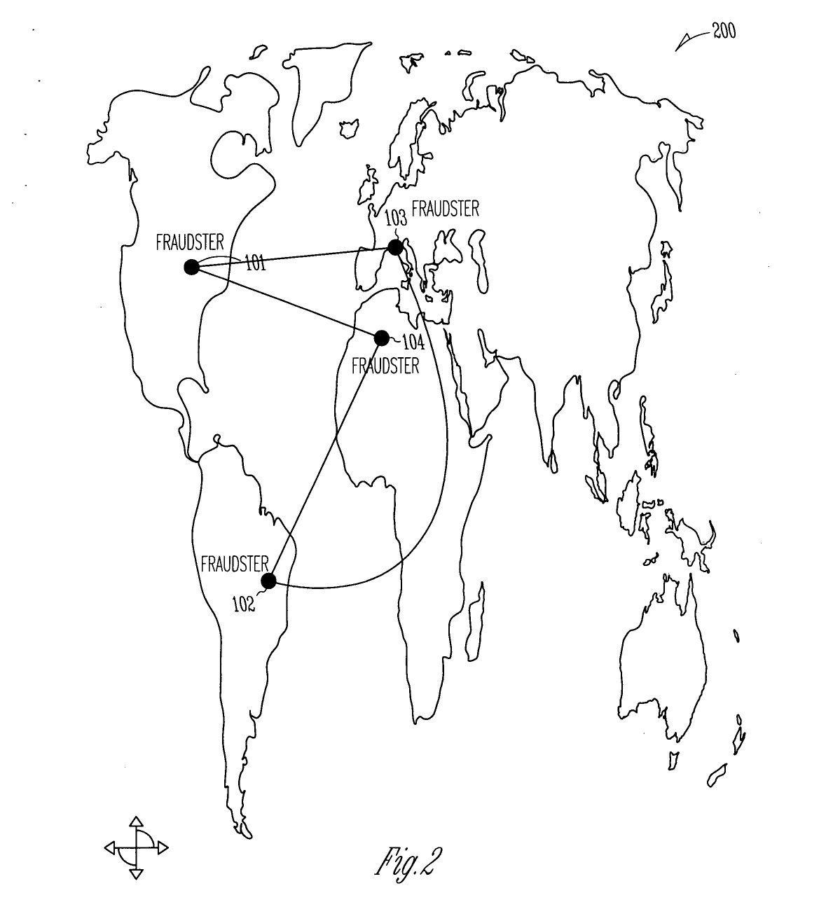

FIG. 2 is a diagram illustrating an example network 200. Illustrated is a fraudster 101, a fraudster 102, a fraudster 103, and a fraudster 104. Fraudster 101 and fraudster 104 are connected via an edge. Fraudster 103 and 104 are connected via an edge, and fraudster 102 and 104 are connected via an edge. As illustrated, in some cases this network may be cyclic or acyclic, and may be composed of a hierarchy of networks. This network 200 is superimposed upon a map of the world showing how these various fraudsters may be connected across international boundaries and, in fact, can together form a fraudster network. The edges in this network 200 may represent, for example, a share or common fraudulent scheme, or some other basis for coordinated activity. In the alternative these edges may represent the fact that the fraudsters know one another. As illustrated, in some cases this network may be cyclic or acyclic, and may be composed of a hierarchy of networks.

FIG. 3 is a diagram illustrating an example network 300. This network 300 illustrates various fraudsters and normal actors, and their relationships. Illustrated is a normal actor 301, a normal actor 302, a normal actor 303, a normal actor 304 and a normal actor 305 and normal actor 306. Connecting normal actor 302 and a fraudster 103 is an edge. There is also an edge between normal actor 302 and normal actor 303. An additional edge exists between normal actor 306 and fraudster 104. A further edge exists between normal actor 301 and normal actor 305. Additionally, an edge exists between normal actor 305 and normal actor 304. Further, an edge 307 may exist between fraudster 102 and normal actor 304. As illustrated, in some cases this network may be cyclic or acyclic, and may be composed of a hierarchy of networks.

In some cases, an edge between normal actors may denote legal activity, where as an edge between fraudsters may denote illicit activity. In some cases, the determination of whether or not an edge or connection exists between a fraudster and normal actor may be of critical importance. For example, if an edge or connection 307 does in fact exist between normal actor 304 and fraudster 102, this may mean that normal actor 304 is in fact not a normal actor, but a fraudster. The determination of whether or not a connection exists between, for example, a fraudster and a normal actor may be based upon the activities and attributes of that normal actor, and whether those activities or attributes constitute fraudulent behavior, such that, for example, the normal actor 304 could be considered to be a fraudster, similar to, for example, fraudster 102.

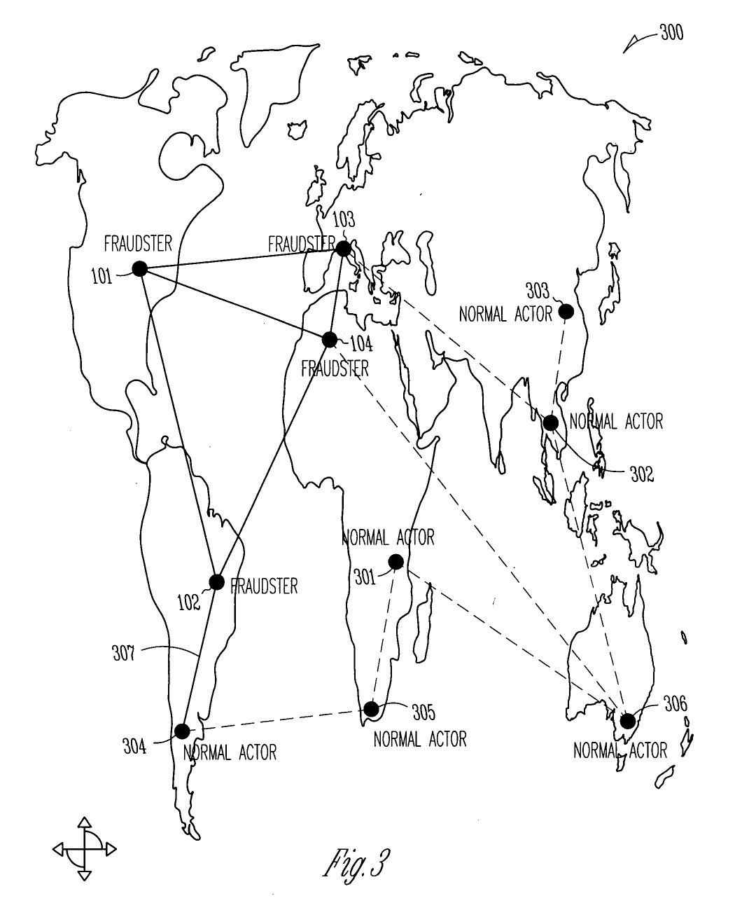

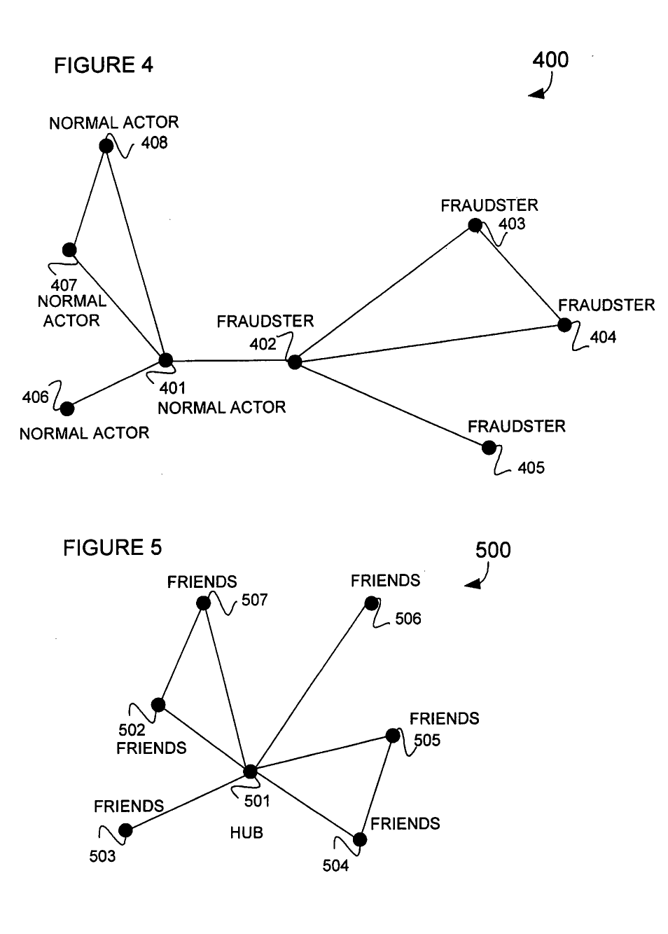

FIG. 4 is a diagram illustrating and example network 400 describing the connection of two sub networks over a bridge. Illustrated is a first sub network composed of normal actor (e.g., Nos. 401, 406, 407, and 408), and a second sub network composed of fraudsters (e.g., Nos. 402-405). This network 400 may be spread out across a large geographical region (see e.g., network diagram 300) or it may not have any geographical characteristics. As illustrated, in some cases this network may be cyclic or acyclic, and may be composed of a hierarchy of networks.

In some embodiments, the existence of one bridge between two otherwise distinct sub networks can serve as the basis for determining whether the entire sub network is composed of fraudsters. For example, in some cases, the fraudulent activities of an entire sub network may be premised upon the activities of one member of the network (e.g., normal actor 401 or fraudster 402). This is not limited to the fraud context, for it may be the case that the activities of a legal sub network may be premised upon the activities of one member of the network. For example, if the members of a network all have an interest in fishing, yet only one member of the network has a boat, the entire network may be dependent upon that one member with the boat to go fishing.

FIG. 5 is a diagram illustrating and example network 500 illustrating a social network composed of a hub node 501 and various friend nodes (e.g., Nos. 502-507). These various nodes may be associated based upon certain shared attributes (see e.g., a normal actor attribute list below) such as an interest in purchasing a automobile, or some other shared attribute. In some embodiments, where certain members of a social network express interest in purchasing a good or service, other members of the same network may be marketed to with solicitations to purchase the same good or service that the other members of the network expressed interest in purchasing. For example, if friend nodes 503 and 504 expressed interest in purchasing a car, then friend nodes 506 and 507 may be marketed to via a car advertisement or other similar solicitation. In some cases, those attributes that define a member a being apart of a network, may be leveraged to solicit a member to purchase a good or service. As illustrated, in some cases this network may be cyclic or acyclic, and may be composed of a hierarchy of networks.

### A System for Building Fraud and Marketing Network Models

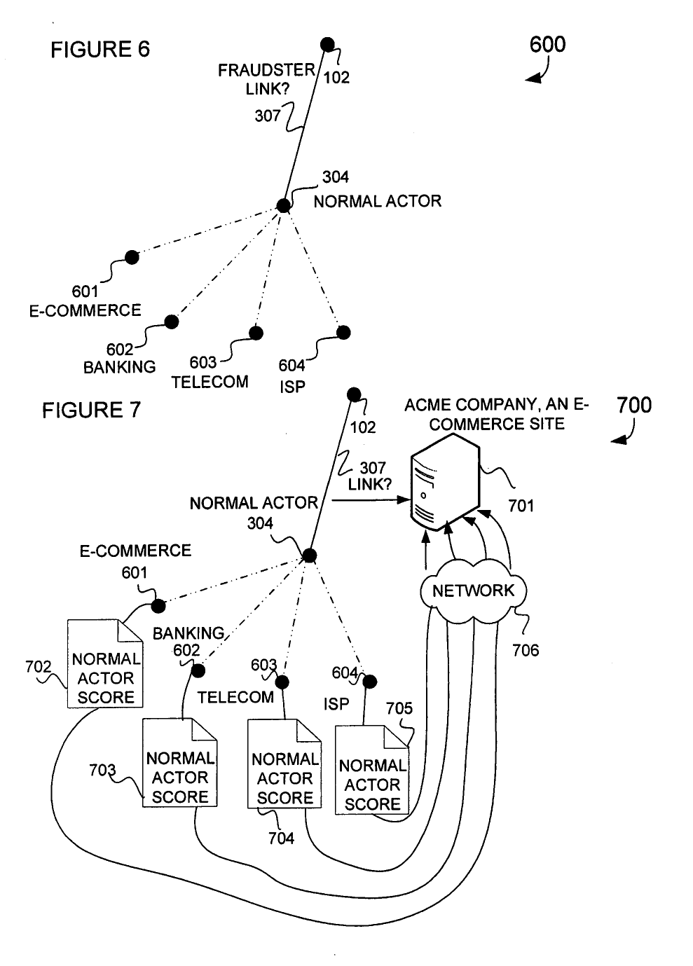

FIG. 6 is a diagram illustrating an example network 600 describing the relationship between fraudster 102 and normal actor 304, and whether or not a link, such as 307, exists between these parties. Illustrated is an e-commerce site or node 601, a banking site or node 602, a telecom site or node 603, and an Internet Service Provider (ISP) site or node 604. Various links exist between these various nodes (e.g., 601-604) and the normal actor 304. In some cases, activities engaged in by the normal actor 304 and this actor's relationship with one or more of the various nodes 601, 602, 603 or 604 may be used to determine whether or not a link, such as link 307, or relationship exists between the normal actor 304 and the fraudster 102. For example, if normal actor 304 and fraudster 102 both use the same IP address, if they share a bank account, and/or if they use the same cell phone, this may denote a link 307 existing between the normal actor 304 and fraudster 102.

FIG. 7 is a diagram illustrating an example network 700 describing an example link query made by, for example, an e-commerce site. Illustrated is an e-commerce site 701 making an enquiry as to whether or not a link 307 exists between the fraudster 102 and the normal actor 304. In order to make this query, the e-commerce site 701 may elicit information from the previously described sites 601, 602, 603 and/or 604. The type of information elicited by the e-commerce site 601 could be, for example, a normal actor score, such as, for example, normal actor score 702, 703, 704 or 705. These scores are generated by their corresponding nodes. Such that, for example, an e-commerce site 601 may generate its own normal actor score 702. Similarly, a banking site 602 may generate its own normal actor score 703. A telecom site 603 may generate a normal actor score of 704. And further, an ISP 604 may generate a normal actor score 705. These scores may be requested over a network 706 by the e-commerce site 701. Once this information is received (e.g., the normal actor scores) then the e-commerce site 701 may be able to make a determination as to whether or not a link 307 exists between the normal actor 304 and fraudster 102. The sub-network comprising, for example, nodes 601, 602, 603, 604, and 701 may be referred to as merchant network.

In some embodiments, these scores are based upon activities engaged in by, for example, the normal actor 304. For example, if the normal actor 304 recently opened a number of accounts with each of the sites (e.g., 601, 602, 603 etc.) then this may lower their score. If, however, their accounts have been open for a long period of time and have been consistently used, then this may justify a higher score. In some cases, the score is standardized based upon certain standards agreed upon by the sites that make up the merchant network.

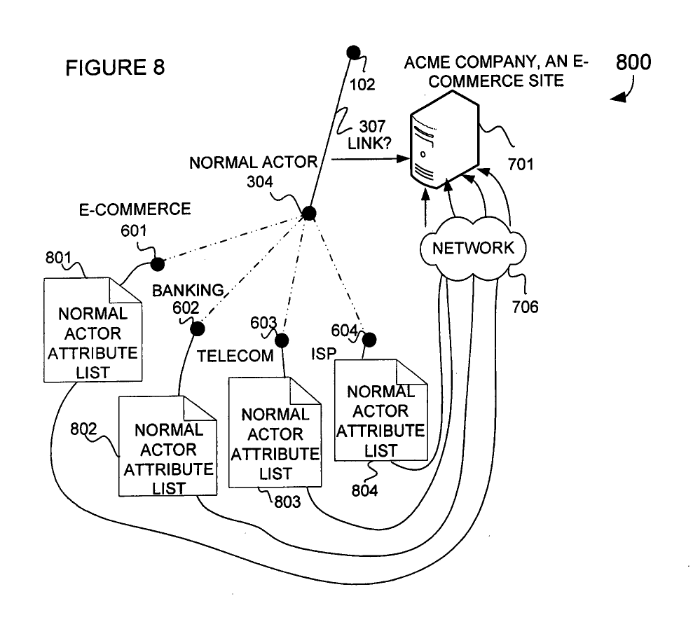

FIG. 8 is a network diagram 800 illustrating a link determination between the normal actor 304 and the fraudster 102 based upon a list of attributes. Illustrated is a normal actor attribute list 801 generated by an e-commerce site 601, a normal actor attribute list 802 generated by a banking node 602, a normal actor attribute list 803 generated by a telecom node 603 and a normal actor attribute list 804 generated by an ISP 604. Once these lists are generated, they are then sent over a network 706 to an e-commerce site 701. Different than a normal actor score (e.g., 502-505) where there is a raw numerical score generated by one of the, for example, e-commerce site 601, banking site 602, etc. In the present case a list of attributes is generated. In some cases, this list of attributes may be specific enough such that more detail may be provided with regard to the normal actor 304. Put another way, rather than having a fairly generic score that could be used to rate a normal actor that could be then allowed to provide a determination as to whether a link 307 exists with the fraudster 102, the normal actor attribute list allows for specific details regarding the normal actor to be provided. Details as will be more fully described below. These details can then be processed by, for example, an e-commerce site 701 for the determination of whether the link 307 exists between the normal actor 304 and the fraudster 102.

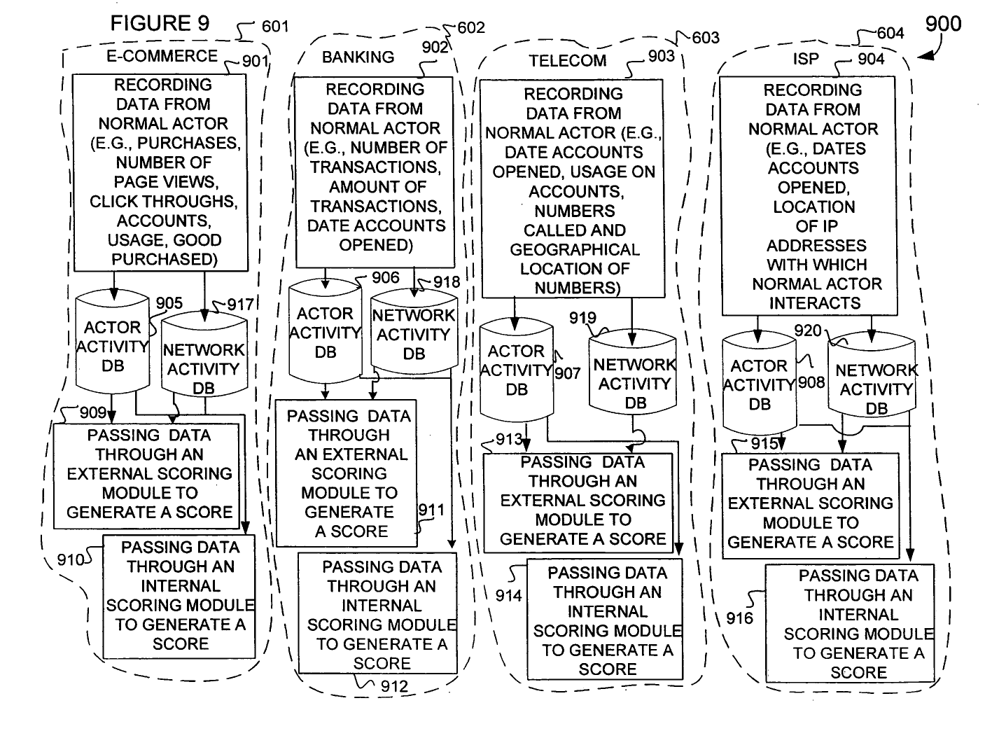

FIG. 9 is a flowchart showing an example method 900. Illustrated is a module 901 that records data from a normal actor regarding transactions that have taken place on the e-commerce site 601. For example, the e-commerce site 601 may, for example, record the purchases made by the normal actor, the number of page views made by the normal actor and what was viewed, the number of click-throughs, the number of accounts opened or used to transact business on the e-commerce site, and, for example, may track what actual goods were purchased. Once this data is tracked, it is then recorded into, for example, a database 905 that records all the actor's activities on the e-commerce site 601. In some embodiments, a database 917 is implemented that stores data relating to a network that an individual is apart of and the activities undertaken by the individuals that make up a network as this network relates to an e-commerce site 601. Next, in some cases, a module 909 is executed that passes data from the actor activity database 905 to an external scoring module that is then used to generate a score. Additionally, in some cases, data from the actor activity database 905 is passed to a module 910 that creates an internal score for the normal actor. In some cases, the external score will be based on some type of standardized value-set, wherein certain activities engaged in by the normal actor (e.g., purchases, accounts opened, the newness of the accounts opened) will be evaluated based upon some type of agreed upon or conventional standards. In contrast, an external scoring module may generate an internal score based only upon the standards and criteria generated by the e-commerce site 601 itself. As with the database 905, this database 917 also passes data to the modules 909 and 910.

Further describe is a module 902, utilized by a banking site or node 602. This module 902 records data for the normal actor that that normal actor transacts with the node 602. This data may include, for example, the number of transactions engaged in, the amount of the transactions, the date on which certain accounts were opened and other information regarding what type of activities the normal actor has engaged in with the site 602. Additionally described is a database 906 that records all of the activities engaged in by the normal actor. Once recorded, a module 911 may be implemented that takes this data from the database 906 and generates an external score. Again, this external score may be based upon certain standards and criteria that are standardized within an industry or network (e.g., a merchant network). Additionally depicted is a module 912, used to generate an internal score. This internal score will be based upon certain criteria that have been generated by the banking site 602 itself. In some embodiments, a database 918 is implemented that stores data relating to a network that an individual is apart of and the activities undertaken by the individuals that make up a network as this network relates to a banking site 602. As with the database 906, this database 918 also passes data to the modules 911 and 912.

Also described is a module 903 utilized by a telecom site 603. This module 903 may record all normal actor data including, for example, the date certain accounts were opened, the usage on certain accounts, the numbers called and the geographic location of the numbers called, utilizing, for example, a telephone account operated by the telecom 603. This data, in some cases, may be stored to a database 907. Once stored, a module 913 may be implemented that generates an external score based upon certain industry or network (e.g., a merchant network) standards. These standards may reflect how to score certain activities based upon the data contained in the database 907. Additionally described is a module 914, used to generate an internal score based upon user activity data contained in the database 907. These internal scores may be used by the telecom to evaluate the user's activities. In some embodiments, a database 919 is implemented that stores data relating to a network that an individual is apart of and the activities undertaken by the individuals that make up a network as this network relates to a telecom site 603. As with the database 907, this database 919 also passes data to the modules 913 and 914.

Moreover, additionally described is a module 904, residing on an ISP 604 site. This module 904 will record data regarding the normal actor's activities on the ISP site 604. These activities may include the date certain accounts were opened, the location of the IP address with which the normal actor interacts, and other relevant information. This data will then, in some cases, be sorted in database 908. In some cases, a module 915 is implemented that is an external scoring module that generates an external score based upon certain industry or network (e.g., a merchant network) standards. This external score will be generated from data contained in the database 908. Further illustrated is a module 916 that will generate an internal score to be utilized by the ISP 604. This internal score again will be based upon the data contained in the database 908. In some embodiments, a database 920 is implemented that stores data relating to a network that an individual is apart of and the activities undertaken by the individuals that make up a network as this network relates to an ISP site 604. As with the database 908, this database 920 also passes data to the modules 915 and 916.

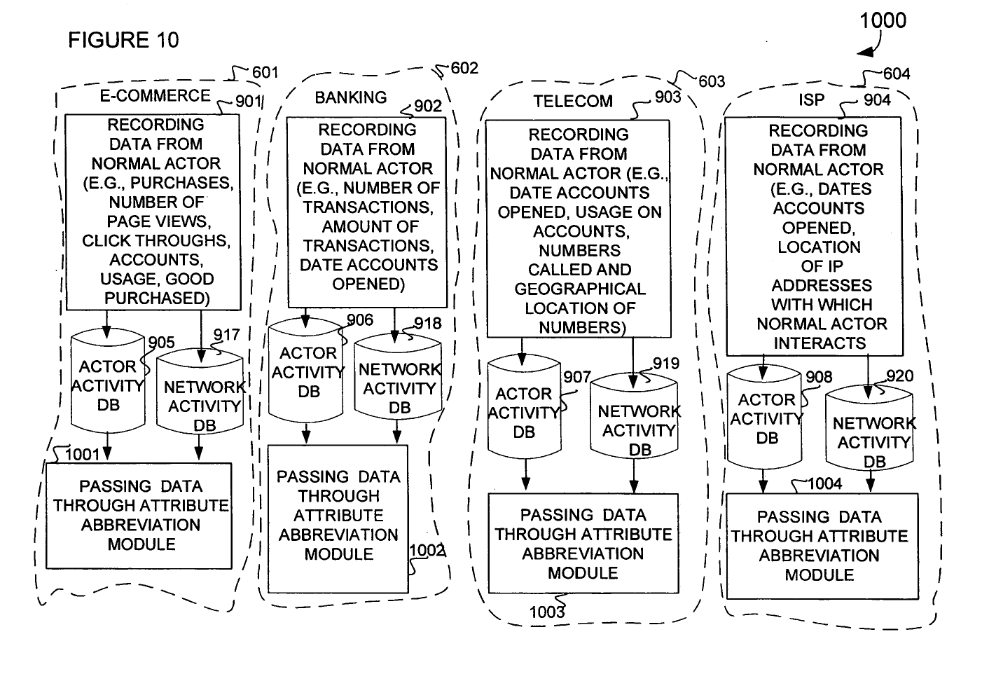

FIG. 10 is a flowchart illustrating an example method 1000. Illustrated is a module 1001 residing on an e-commerce site 601, wherein this module 1001 generates attribute abbreviation data through obtaining recorded data from a database 705. Also described is a module 1002 that generates attribute abbreviation data based upon banking data obtained from the database 706. Additionally described is a module 1003 that generates attribute abbreviation data based upon telecom data contained in the database 707. Moreover, a module 1004 is described that generates attribute abbreviation data based upon ISP data obtained from a database 708. This attribute abbreviation data may in some cases allow for a more granular description of the activities of a normal actor as compared to a global score, which provides a score that, while based upon certain industry or network (e.g., a merchant network) standards, fails to provide granularity as to what the score actually means, in terms what specific activities have (e.g., the normal actor engaged in). Also described are various databases 917-920 that pass network activity data relating to the various networks, and the individuals that make up these networks, to modules 1001-1004 respectively. Once this network data is passed, an abbreviated attribute list for a network us generated. As with the databases 905-908, a network activity database exists for each site (e.g., 601-604) to track networks activities with respect to a site.

In some embodiments, the global score may be a general score relative to the population of all possible persons, whereas in other cases the global score may be relative to a particular network that a member may be apart of or participate within (e.g., a network score). For example, relative to the universe of all possible persons a score may be high, while relative to the other members of a network that one is apart or a score may be low. Some example embodiments may implement modules 909-916 that provide for both a general score and a network score.

### An Implementation

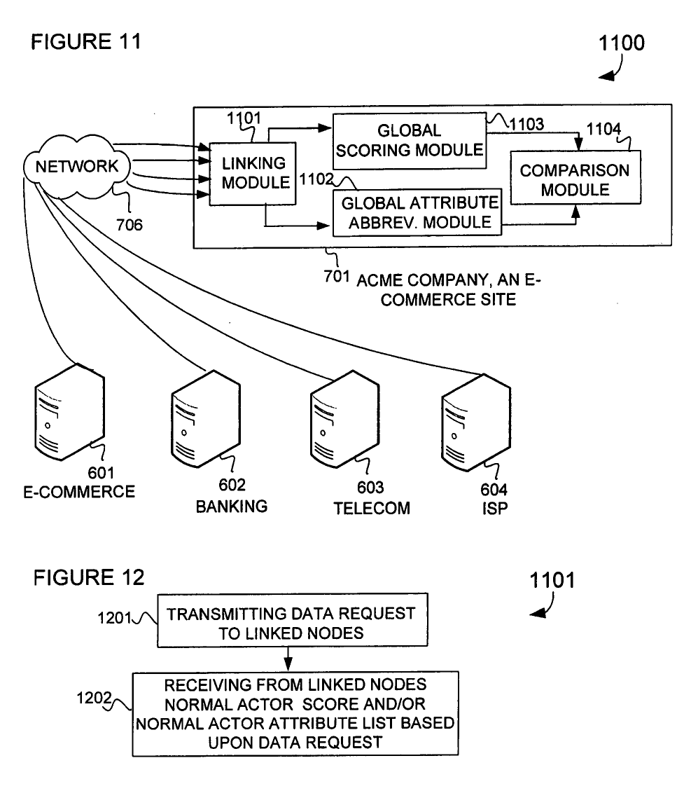

FIG. 11 is a block diagram illustrating an example system 1100. Illustrated is a linking module 1101 that is operatively coupled to a global scoring module 1103 and a global attribute abbreviated module 1102. These modules 1102 and 1103 are, in turn, operatively coupled to a comparison module 1104. These various modules (e.g., 1101-1104) may, in some embodiments, reside on a node 701, which in some cases may be a computer system. Further, the linking module 1101 may be operatively coupled to a network 706, such that the e-commerce site 601, banking site 602, telecom site 603 and ISP site 604 may be able to send data in the form of a normal actor score (see e.g., 702-705) or a normal actor attribute list (see e.g., 801-804) to the linking module over the network 706.

FIG. 12 is a flowchart illustrating an example method used to implement module 1101. Describe is a module 1201 that transmits data requests to various linked sites. In some cases, these linked sites are, for example, sites 601, 602, 603 and/or 604. Next, in some cases, a module 1202 is implemented that receives from the linked sites normal actor scores and/or normal actor attribute lists based upon requested data. A normal actor may include, for example, normal actor 304.

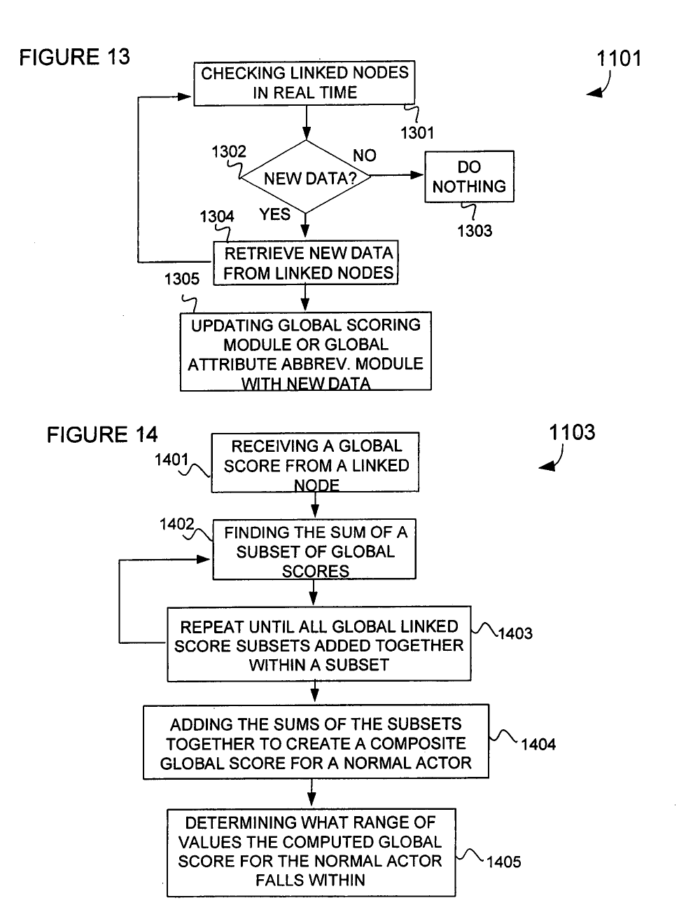

FIG. 13 is a flowchart illustrating an example method used to implement module 1101. Illustrated is a module 1301 that checks linked sites in real time. These linked sites may include, for example, sites 601, 602, 603 and/or 604. Next, once the linked sites are checked, a decisional module 1302 is executed that determines whether or not new data exists regarding, for example, a normal actor 603 on one of the linked sites. If no new data exists, then a module 1303 is implemented, wherein nothing is done. If, however, there is new data, then a module 1304 is implemented that will choose new data from the linked sites. This process of checking the linked sites continues in a loop, wherein the linked sites are continuously checked for new data regarding a normal actor. Once the module 1304 is executed and new data is retrieved from a linked node, then a module 1305 is executed that updates a global scoring module, or a global attribute abbreviation module with new data (e.g., 1103 or 1102).

FIG. 14 is a flowchart illustrating an example method to implement module 1103. Illustrated is a module 1401 that receives a global score from a linked node (e.g., 601, 602, 603 and/or 604). Once a global score is received, then a module 1402 is executed that finds the sum of a subset of the global scores. In some cases, global scores are divided between the various linked sites and the sum of scores is found using a composite (e.g., a composite method) of these scores derived from the linked sites. Once the sum of a subset of global scores is found, then a module 1403, wherein all the scores of each of the subset sums are added together within a subset, until all the scores within a subset have been added. Once this occurs, then a module 1404 is executed that adds the sums of the subsets together to create a composite global score for a particular normal actor, such as normal actor 304. Once this composite global score is generated, a module 1405 that determines what range of values the computed global score falls within for a particular normal actor. In some cases, a range of score values will be generated, wherein this range represents, at one end, the probability that a normal actor will, for example, be a part of a fraudulent scheme, and at another end that the normal actor is not part of a fraudulent scheme. This range of values may be generated based upon certain agreed to standards within an industry.

A composite score may be illustrated with the following example. Assume e-commerce site 601 and ISP 604 each generate a global score of 65 and 75 respectively. Also assume that banking site 602 and telecom site 603 generate scores of 55 and 85 respectively. Once these scores are generated, then subset of these score are added together and analyzed such that after each addition, the scores are compared to ensure that there is consistency among the scores. For example, 65 and 75 are added together to create a global score of 140. Then 55 and 85 are added together to create a global score of 140. The sum of these two sub sets (e.g., the subset containing the scores from 601 and 604, and the subset containing scores from 602 and 603) are then compared so as to maintain and retain confidence in the scores. Specifically, in the present example both sums equal 140 such that there is a high degree of confidence in the conjecture that the score for both subsets represents the same individual (e.g., a normal actor). Put another way, if one acts as a fraudster with regard to one site (e.g., banking site 602), then it is likely that they will act as a fraudster with regard to a second site (e.g., telecom site 603). Taken together these two sub set scores form a global composite score which here is 280. In some cases, a standard deviation value will be used to determine whether two or more sub set scores are deemed to be approximately equal.

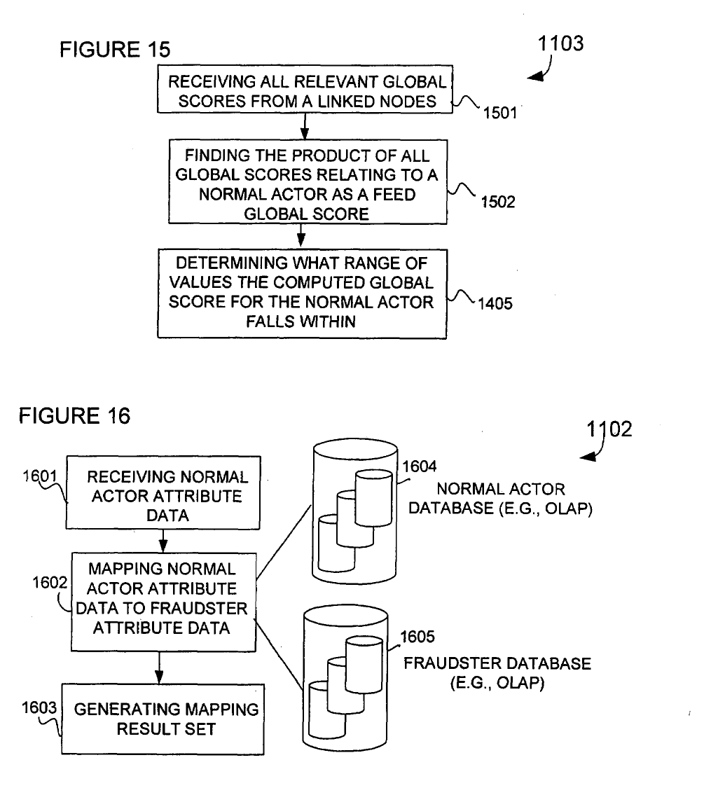

FIG. 15 is a flowchart illustrating an example method used to implement a module 1103. Described is a module 1501 that receives all relevant global scores from linked sites (e.g., 601, 602, 603 and 604). Once these relevant global scores are received from linked sites, a module 1502 is executed that finds the product of all the global scores relating to a normal actor. This product may be referred to as a feed global score (e.g., a feed method). Once this feed global score is generated, a module 1405, as previously described, is executed.

Some example embodiments may implement a feed global score. In the feed global score scenario, a score from one site (e.g., banking site 602) it provided to a second site (e.g., telecom site 603) where the product of these two scores is determined. Once determined, then this product is provided to a third site (e.g., e-commerce site 601) where the product is determined and so on until the product of all global scores for all members of the network is calculated. For example, if the global score for the banking site 602 is 0.90, and the global score for the telecom site 603 is 0.80, then the product score will be 0.72. The aggregate of these products will produce a global confidence score.

In some embodiments, a concept of optimism or pessimism may be used to evaluate a global conduct score. In some cases a global conduct score will be evaluated from the perspective of a specific site, and their own interests and values, such that one score may be viewed in a positive light by one site, but the same score will be viewed in a negative light by another site. For example, while one site may view a score of 30 on a scale of 0-100 with 100 being the best rating, as a low score, a site that tailors itself to those normal actors with a low score may view such a score in a positive light as a potential business opportunity.

FIG. 16 is a flowchart illustrating an example method use to implement a module 1102. Described is a module 1601 that receives normal actor attribute data. This normal actor attribute data is then passed to module 1602 that maps the normal actor attribute data to known fraudster attribute data. This mapping occurs utilizing a database 1604, containing a normal actor data, and a database 1605, and containing fraudster data. Once this mapping occurs, a module 1603 is executed that generates a mapping result set, wherein, an actor such as normal actor 304 and his or her attributes will be compared to a fraudster's attributes. In some cases, these databases may utilize OLAP and data structures contained therein, such as multi-dimensional and/or hyper cubes, to provide a multi-dimensional analysis of the data. For example, this database 1604 and 1605 may be operatively coupled to the e-commerce site 701 via a network such as an internet, Local Area Network (LAN), Wide Area Network (WAN) or some other suitable network. In some embodiments, this e-commerce site 701 may utilize an application server such as a Java Enterprise Edition (Java EE or J2EE) certified server using the Java OLAP Interface, a Microsoft SQL server running, for example, Microsoft Analysis Services or some other suitable application server. This application server may then manage an OLAP and/or relational database such as is described above (see e.g., description of databases 905-908 and 917-920)

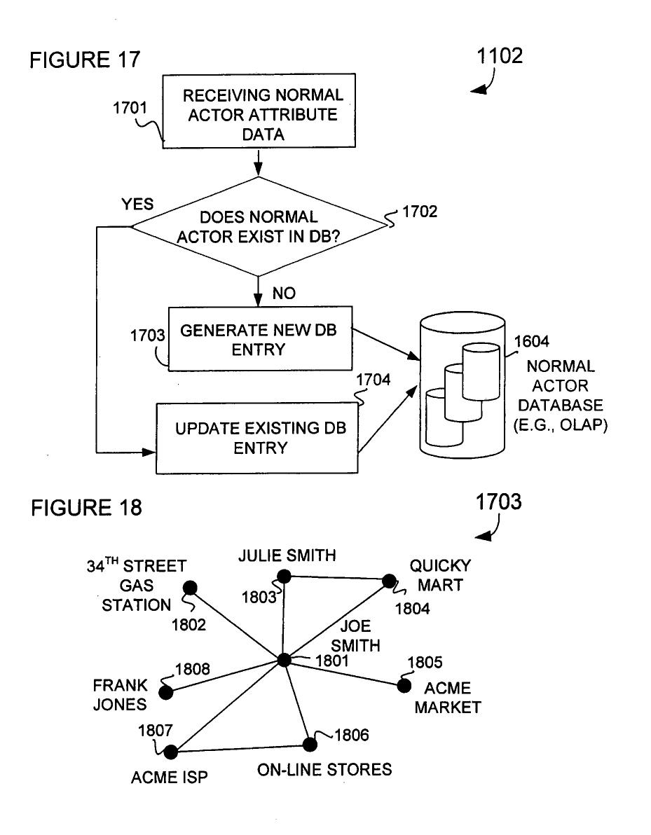

FIG. 17 is a flowchart illustrating an example method used to implement a module 1102. Illustrated is module 1701 that receives normal actor attribute data. Once received, a decisional module, 1702 is executed that determines whether or not the normal actor presently exists in a database. If this module 1702 evaluates to no, a module 1703 is executed that generates a new database entry. In some cases, this database is the previously described 1604. Where the decisional module evaluates to true or yes, a module 1704 is executed that updates the existing database entry regarding the normal actor. In some cases, the received normal actor attribute data relates to merely the normal actor's activities with regard to one of the aforementioned nodes (e.g. 601-604).

For example, if the normal actor opens a new account on an ISP 604 or opens a new banking account with the banking node 602, then data reflecting these new accounts may be received at the module 1701, to update to normal actor database 1604. And again, if the normal actor clicks through a number of web pages on the e-commerce site 601, then these various click-throughs may also be recorded in the database 1604.

In some embodiments, the normal actor's activities, irrespective of whether or not they are related to a fraudster's activities, may be recorded into the database 1604, for subsequent use for the purposes of marketing, sales or other types of activities. For example, if it is observed that the normal actor 304 is purchasing a number of music compact discs on the e-commerce 601, then the normal actor 304 may be prompted with certain marketing materials relating to the purchase of music compact disks (CDs). And again, if the normal actor 304 is observed to have opened a new telecom account, in the form of, for example, a cell-phone account, with the node 603, then the user may be prompted with marketing materials regarding accessories for cell-phones. And again, if it is observed that the normal actor 304 has not been transacting business on, for example, the e-commerce site 601, then they may be prompted with marketing materials regarding new goods and services available on the e-commerce site 601 that they may be interested in purchasing. In some cases, the ability to monitor the activities of the normal actor, will allow for determination to be made as to what status the normal actor is with regard to the purchase or sale of goods and services, their ability to obtain goods or services, and/or their interest in purchasing or obtaining goods or services.

FIG. 18 is a diagram illustrating an example network generated by the module 1703. Described is a source node 1801, titled “Joe Smith”. In some cases, Joe Smith, may represent the normal actor 304. An edge or link exists between the source node 1801 and a sink node 1802 titled “34th Street Gas Station”. A further node 1803, titled Julie Smith, another 1804, titled “Quicky Mart” and, for example, a further sink node 1805 titled “Acme Market”. These various sink nodes and the link between each of these sink nodes and Joe Smith (e.g. 1801) may be established based upon data received from one of the previously described sites 601, 602, 603 and/or 604. For example, if Joe Smith transacts business with node 1802, the 34th Street Gas Station, then the banking site 602 may provide information to this effect. Further, if Joe Smith has a teleconference (e.g. 1803) the telecom 603 site may provide this information to one evaluating Joe Smith's activities (e.g., e-commerce site 701).

Additional illustrated is a sink node 1808 titled “Frank Jones”, a node 1807 titled “Acme ISP”, and a node 1806 titled “On-line Stores”. As previously described, the link or edge between this node 1801 and the other nodes may be determined based upon information provided regarding Joe Smith from the previously described network nodes 601-604. For example, ISP site 604 may provide information regarding the Acme ISP node 1807 and link thereto. As illustrated, in some cases this network may be cyclic or acyclic, and may be composed of a hierarchy of networks.

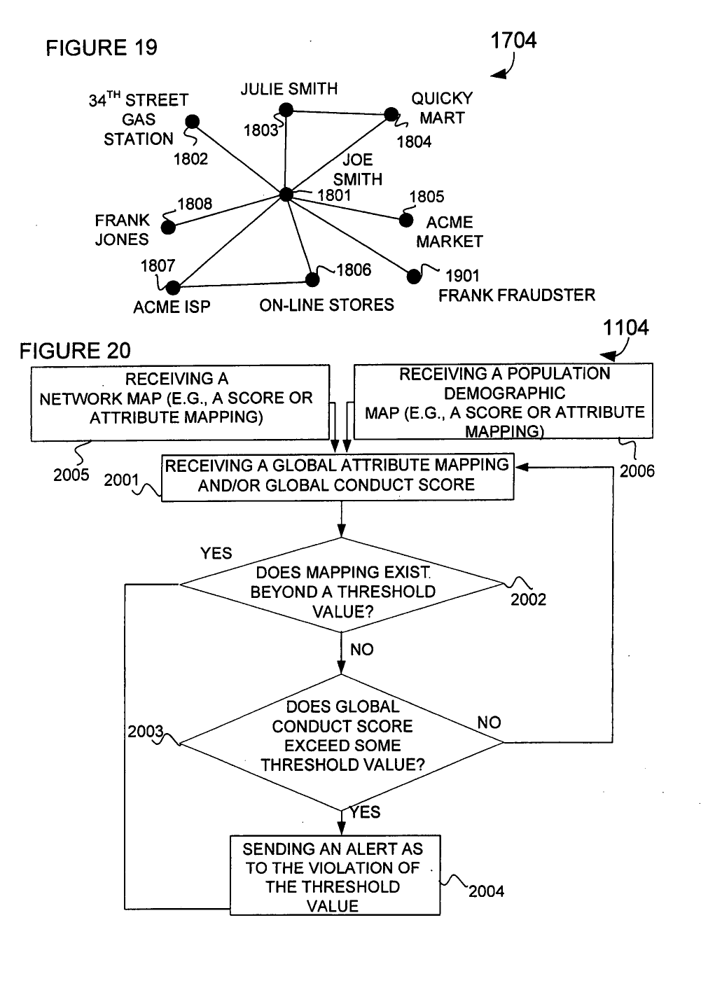

FIG. 19 is a network diagram illustrating the updating of an existing database via a module 1704. Described is a sink node 1901 titled Frank Fraudster that is connected via an edge to the Joe Smith node 1801. In some cases, this Frank Fraudster node 1901 may, for example, be the same as a fraudster node 102 such that a link exists between Joe Smith and a fraudster. In such a case the determination of whether a link exists between the two, would be determined to be true and hence for example a link 307 would be deemed as a valid link or edge between Joe Smith and Frank Fraudster. As previously described, this link may be based upon a normal actor global score provided by one or more of the previously described sites 601, 602, 603 and/or 604. In the alternative, and/or in addition to, this link may be based upon an attribute list provided by these same sites. Put another way, if the global score is high, then there is a high probability of a link. Or, for example, if both Frank Fraudster node 1901 and the Joe Smith node 1801 share certain attributes, then a link may be found to exist. A high score and/or whether certain attributes are shared or not may be based upon empirical testing and/or modeling, or conventions arrived at by merchant network participants. As illustrated, in some cases this network may be cyclic or acyclic, and may be composed of a hierarchy of networks.

FIG. 20 is a flowchart illustrating example method used to implement a module 1104. Described is a module 2001 that receives a global attribute mapping and/or a global conduct score. Once received, a decisional module 2002 is executed that determines whether or not a mapping exists beyond a certain threshold value. If this decisional module 2002 evaluates to false or no, then a second decisional module 2003 is executed that determines whether or not a global context score exceeds some threshold value. Where this module evaluates to false or no then the module 2001 is re-executed. However, where the module 2003 evaluates to true then a module 2004 is executed that sends an alert as to a violation of a threshold value. In some cases, this alerting may be by way of a signal sent to a computer system informing it of the existence of a fraudster or fraudsters' network. In still other embodiments, this alert may be sent to a computer system to advise the users of a system as to a marketing opportunity. This alert may be a screen prompt, email message, graph showing behavior over time or some other suitable alert. This same module 2004 is executed where the decisional module 2002 evaluates to yes or true. In some cases, an optional module 2005 and 2006 are implemented. Module 2005 receives population demographic information, whereas module 2006 received network demographic information. In some cases modules 1102 and 1103 may break a global conduct score or attribute model down into network specific details as opposed to population specific details. This process is more fully described below.

In some cases where a conduct score exceeds some threshold value or the mapping of attributes exceeds some threshold value then an alert is sent. In some cases, this alerting may be by way of a signal sent to a computer system informing it of the existence of a fraudster or fraudsters' network. In still other embodiments, this alert may be sent to a computer system to advise the users of a system as to a marketing opportunity. This alert may be a screen prompt, email message, graph showing behavior over time or some other suitable alert. Where, for example, attributes exceed threshold value there is a certain isomorphism or correspondent mapping between, for example, a normal actor's map and that of, for example, a fraudster. Where there is a high level of correspondence between these two maps, that is, for example, the normal actor maps too many of the same attributes or nodes that the fraudster maps to, then it may be deemed that the normal actor is in fact a fraudster. Similarly where a global conduct score exceeds some certain threshold value then an alert will be sent to the effect that the normal actor may be a fraudster.

In some embodiments, as described elsewhere, a global conduct score or attribute list may reflect a score relative to an entire universe of all possible persons (e.g., a demographic score), whereas in other cases the score may only relative to the particular network with which one is associated (e.g., a network score). This demographic score may tell one about a particular persons (e.g., a normal actor 304) status with respect to the universe in general, while the network score may provide a level of granularity necessary for deep analysis relating to this person's activities within a network. This network score may be seen as a sub class or values or scores derived from the global conduct score or attribute list.

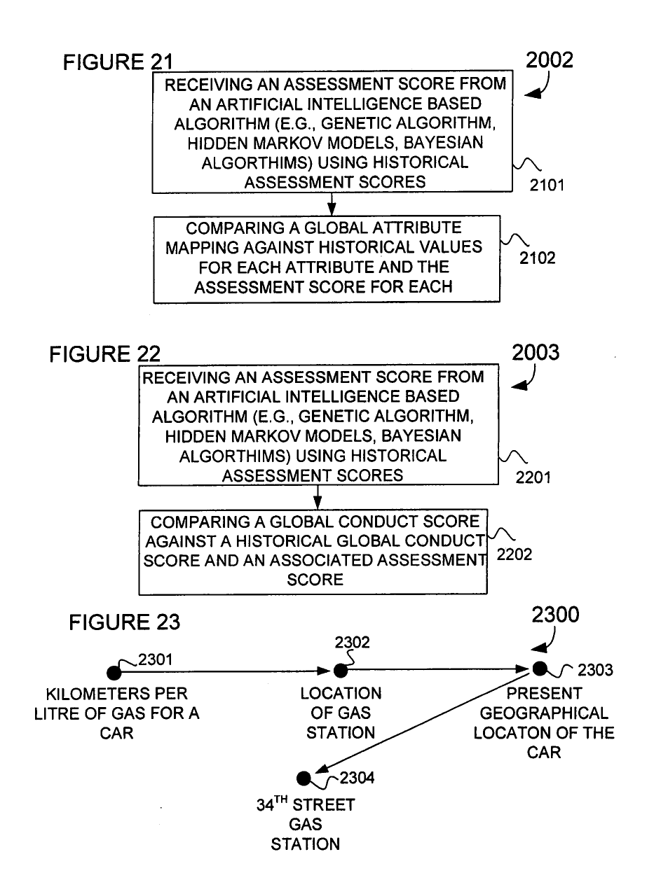

FIG. 21 is a flowchart illustrating an example method used to implement a module 2002. Described is a module 2101 that receives an assessment score from an AI based algorithm, wherein this AI based algorithm utilizes certain historical assessment scores. The AI algorithm may utilize a feedback loop so as to continually optimize the models, data sets, or rules sets that it creates. In some cases, an AI algorithm may be used to anticipate attributes describing the expected behavior of a normal actor based upon historical assessment scores. These historical assessment scores may be based upon certain attributes viewed over time utilizing, for example, OLAP. Once the assessment scores are received, then a module 2102 is executed that conducts a mapping of global attributes assessment scores to historical attribute assessment scores received from an AI algorithm. If the assessment score for the global attributes exceeds some standard deviation when mapped to the historical attribute assessment scores, then the member of the network (e.g., normal actor 304) associated with the assessment score may be flagged and an alert ultimately sent (see e.g., module 2004). This process may be used to flag not only potentially fraudulent actors, but also actors who may be interested in particular goods or services (e.g., friends 502-507).

FIG. 22 is a flowchart illustrating an example method used to implement module 2003. Described is a module 2201 that receives an assessment score from a global conduct score generated by an AI algorithm that utilizes historical global conduct scores in generating the assessment score. The AI algorithm may utilize a feedback loop so as to continually optimize the models, data sets, or rules sets that it creates. Once received, module 2202 is implemented that compares the assessment score for a global conduct score and an assessment score provided by the AI algorithm via the module 2201. If the assessment score for the global conduct score exceeds some standard deviation, then the member of the network (e.g., normal actor 304) associated with the global conduct score may be flagged and an alert ultimately sent (see e.g., module 2004). This process may be used to flag not only potentially fraudulent actors, but also actors who may be interested in particular goods or services (e.g., friends 502-507). In some cases, this alert may be by way of a signal sent to a computer system informing it of the existence of a fraudster or fraudsters' network. In still other embodiments, this alert may be sent to a computer system to advise the users of a system as to a marketing opportunity. This alert may be a screen prompt, email message, graph showing behavior over time or some other suitable alert.

Once the assessment score is received, a module 2202 is executed that compares a global conduct score against a historical global conduct score and an associated assessment score. As described above, where the assessment score value is exceeded an alert will be sent that this value has been exceeded.

In some embodiments, the exceeding of the assessment score value will denote not only fraud but also may be used to determine a normal actor's buying activities. For example, if a normal actor has recently purchased a large number of goods or services on the e-commerce site 601 or has engaged in a number of banking transactions via the banking node 602 then in such cases the normal actors such as normal actor 304 may be solicited or prompted with various marketing materials asking them to purchase goods or services.

Put another way, if it is observed by these sites that a normal actor has been purchasing a large number of goods or services then they may be prompted with promotional materials relating to additional goods or services that they could purchase. And again, if it has been observed that a normal actor has not been purchasing goods or services this may also serve as the basis for prompting them to purchase additional goods or services.

As previously described, these artificial intelligence algorithms may include for example a genetic programming or genetic algorithm, a hidden markov model, decision trees, a neural network or some other suitable AI algorithm in the AI research field. For example, these algorithms are not limited to AI algorithm, but may be combined with more traditional techniques such as logistic regression where the weights are determined via genetic algorithms. In embodiments where one or more genetic algorithms are implemented, a certain global scores or attributes are selected. This selection may be random or based upon certain groups of associated scores or attributes (e.g., scores or attributes may be associated based upon their usage by a group of normal actors). Once selected, these scores or attributes may be combined together based upon factors including, for example, how common a score or attribute is within a network. This combination of certain scores or attributes may occur through a number or iterations (e.g., 500 iterations) before a final, optimized new score or attribute set is created. Once combined, then a new, optimized score or attribute set is generated for use in evaluating certain normal actors (e.g., 406-408) or other suitable persons (e.g., friends 502-507). In some cases, this new set of scores or attributes may replace an existing set of scores or attributes. As with biological systems, a certain level of elitism may exist such that certain scores or attributes may not be allow to be replaced due to the frequency with which these scores or attributes are used, or their historical association with certain members of a network. For example, in cases where a normal actor or other person in a social network has a very high score, or manifests very desirable attributes over time (e.g., they have a history of purchasing certain good or services), then their score or attributes may not be open to evaluation using a genetic algorithm.

In some embodiments, the genetic algorithm acts as a rules engine so as to process an attribute set which may be referred to as a rules set. The members of this rules set may be rules such as a network participant's (e.g., a normal actor 304) global conduct score, and/or attributes such as, for example, recent behavior on a site (e.g., Nos. 601-604), recent new associations with other participants, making telephone calls from geographical regions never called from, moving money to participants with whom they have never interacted with in the past, adding known fraudsters to a instant message list, emailing known fraudsters, or generally developing associations with new parts of the network. As described above, the genetic algorithm may act on these rules so as to generate new potential rules (e.g., attributes) that a participant may manifest. In some embodiments, it may be left to other algorithms (e.g., an SA algorithm) to determine the probability of these new rules occurring for a participant.

Other types of statistical algorithms may also be implemented. For example, in one embodiment, a SA algorithm may also be implemented, wherein various global scores or attributed for members of a network are replaced with global scores or attributes from other members of the same network. Specifically, in one example case, the most closely related scores or attributes to a target score or attribute are randomly chosen to replace the target score or attribute, hence making a new target score or attribute. Once replaced, then another closest score or attribute to the new target score or attribute is used to replace the new score or attribute as a second new target score or attribute, and the target score or attribute and second new target score or attribute are compared to determine whether they are similar within some standard deviation value. Where they are do fall within a standard deviation value, then the process may continue. Where they are not within a standard deviation, then the process will end (e.g., a termination case). This process of replacement may continue for forever until the termination case is met, or for some predefined number of iterations set by a system administrator or other suitable person. For example, if within a network there is set of global score for member of 50, 55, 57, 45, and 60, then these scores may be used and considered synonymous within the network, so long as some standard deviation value is not exceeded. Again, for example, if a member of a network (e.g., hub 501) is determined to like black sports cars, then this like of black sports cars may be associated with other members of a network (e.g., 505 and 506) who like sports cars, but not explicitly black sports cars. Put another way, through using an SA algorithm certain implicit likes and dislikes may be considered and tested by actually marketing certain good and services to members of a network based upon the likes and dislikes of other members of the network.

In cases where a genetic algorithm is used in combination with an SA algorithm, the genetic algorithm may generate new rules for a particular network participant, but it will be the SA algorithm that determines the probability of and manner by which these rules are swapped between network participants for the purpose of for example marketing. Additionally, in some cases a genetic algorithm and SA algorithm may be used to model potential future fraudulent activity based upon existing data. For example certain rules generated by the genetic algorithm may be maybe associated by the SA algorithm with other network participants and once associated verified through empirical evidence of fraudulent activities.

In addition to certain other AI algorithms may be implemented. For example, an algorithm that generates a bayesian network may be implemented. In certain cases networks such as that depicted in FIG. 18 may be directional and acyclic such that given certain attributes, and then certain other attributes may be predicted. This prediction may be causal or conditional in nature. For example, by implementing a baynesian network, it may be possible to predict the likelihood that one will purchase a good or service given certain conditions.

FIG. 23 is a network diagram illustrating and example bayesian network 2300. Illustrated is a node 2301 representing the kilometers per liter of gas that a particular car consumes. This car could be owned and driven by, for example, friend 502. An edge connects node 2301 and a node 2302 representing the geographical location of one or more gas station relative to the liters of gas a car may have in its tank and the liters per kilometer consumed. Next, an edge connects the location of these one or more gas stations and the present physical location of the car as reflected by node 2303. Connected to this node 2303 is a node 2304 representing the location of a particular gas station the 34^{th} Street Gas Station. By combining the probability of these various events occurring, a probability determination may be made regarding whether, for example, a friend 502 may use the services provided by the 34^{th} Street Gas Station. Where there is a high probability, then the 34^{th} Street Gas Station may want to market good or services to the friend 502.

In some embodiments, the various pieces of information reflected in nodes 2301-2304 may be provided by the various members of a merchant network (e.g., sites 601-604). For example, information for node 2301 may be provided by an e-commerce site 601 where one has provided information about their car to this e-commerce site 601. Further, information for node 2302 may be provided by a banking site 602 that provides credit card processing services to a service station and, hence knows the physical location of the station. Next, information for node 2303 may be provided by an ISP site 604 that can is IP address information to assist in determining physical location. Moreover, the actual location of a gas station (see e.g., node 2304) may be determined by or provided by a telecom site 603.

In some embodiments, the decision as to whether or not to market to a friend 502 may be based upon data provided to the bayesian network from a variety of sources (see e.g., 601-604). For example, account purchase in formation from the banking site 602 may provide details as to what gas stations an individual typically uses. Further, phone call information, from the telecom site 603, showing calls to a particular gas station, may also provide a picture of what gas station one typically interacts with when purchasing gas or other service station related products.

### Design Details

The various above illustrated modules may be implemented into the system together as one static application, or on an as-needed basis. These modules may be written in an object-oriented-computer language such that a component oriented or object-oriented programming technique may be implemented using a Visual Component Library (VCL), Component Library for Cross Platform (CLX), Java Beans (JB), Java Enterprise Beans (EJB), Component Object Model (COM), or Distributed Component Object Model (DCOM) or other suitable technique. These modules are linked to other modules via various Application Programming Interfaces (APIs) and then compiled into one complete server and/or client application. The process for using modules in the building of client and server applications is well known in the art. Further, these modules, and the tiers that they make up, are linked together via various distributed programming protocols as distributed computing modules.

Some example embodiments may include remote procedure calls being used to implement one or more of the above described levels of the three-tier architecture across a distributed programming environment. For example, a logic level resides on a first computer system that is remotely located from a second computer system containing an Interface or storage level. These first and second computer systems may be configured in a server-client, peer-to-peer or some other configuration. These various levels may be written using the above described component design principles and may be written in the same programming language, or a different programming language. Various protocols are implemented to enable these various levels, and components contained therein, to communicate regardless of the programming language used to write these components. For example, a module written in C++ using the Common Object Request Broker Architecture (CORBA) or Simple Object Access Protocol (SOAP) can communicate with another remote module written in Java. These protocols include SOAP, CORBA, or some other suitable protocol. These protocols are well-known in the art.

In some embodiments, the above described components and modules communicate using the Open Systems Interconnection Basic Reference Model (OSI) or the Transmission Control Protocol/Internet Protocol (TCP/IP) protocol stack models for defining network protocols that facilitate the transmission of data. Applying these models, a system of data transmission between a server and client computer system may be described as a series of roughly five layers comprising as a: physical layer, data link layer, network layer, transport layer and application layer. Some example embodiments may include the various levels (e.g., the Interface, Logic and storage levels) residing on the application layer of the TCP/IP protocol stack. The present application may utilize HTTP to transmit content between the server and client applications, whereas in other embodiments another protocol known in the art is utilized. Content from an application residing at the application layer is loaded into the data load field of a TCP segment residing at the transport layer. This TCP segment also contains port information for a recipient application or a module residing remotely. This TCP segment is loaded into the data field of an IP datagram residing at the network layer. Next, this IP datagram is loaded into a frame residing at the data link layer. This frame is then encoded at the physical layer and the content transmitted over a network such as an internet, Local Area Network (LAN) or Wide Area Network (WAN). The term internet refers to a network of networks. Such networks may use a variety of protocols for exchange of information, such as TCP/IP etc., and may be used within a variety of topologies or structures. This network may include a Carrier Sensing Multiple Access Network (CSMA) such as an Ethernet based network. This network may include a CDMA network or some other suitable network.

Some embodiments may include the various databases (e.g., Nos. 905-908 and 917-920) being relational databases, or in some cases OLAP based databases. In the case of relational databases various tables of data are created, and data is inserted into, and/or selected from, these tables using a Structured Query Language (SQL) or some other database-query language known in the art. In the case of OLAP databases, one or more multi-dimensional cubes or hyper cubes, containing multidimensional data from which data is selected from or inserted into using a Multidimensional Expression (MDX) language may be implemented. In the case of a database using tables and SQL a database application such as, for example, MYSQL™, SQLSERVER™, Oracle 8I™ or 10G™, or some other suitable database application may be used to manage the data. In this the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. These tables or cubes made up of tables, in the case of, for example, ROLAP are organized into a Relational Data Schema (RDS) or Object-Relational-Database Schemas (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization, optimization algorithm known in the art.

### Marketplace Applications

In some embodiments, real time data is provided to a member of a network, to allow this member make a determination regarding a normal actor or other member of a social network. This determination may, for example, be with regard to the member's propensity to commit or facilitate fraud, the member's interest in purchasing a good or service, and/or to observe or predict the member's behavior. For example, by using a module 1101, e-commerce site 701 may be able to receive a real-time attribute list (see e.g., 803) regarding cell phone usage from the telecom site 603, a real-time attribute list (see e.g., 804) containing IP address usage from an ISP 604, and a real time attribute list (see e.g., 802) containing bank account information relating to account location from a banking site 602. Once received a module 1102 may be executed so as to generate or update an existing network map, and once updated a module 1104 may be executed to make a determination as too the existence of fraud. Applied to the example case outlined in FIG. 1, by knowing IP address of the fraudsters, the bank account information, and/or cell phone information the geographical location of the fraudsters may be determined and the fraud defeated in real time or near real time.

Applying real time data in the market context, where for example a social network is know, then certain predictions may be made as to the interest that a member of this network might have in purchasing a good or service. For example, by using the module 1101, an e-commerce site 701 may be able to receive a real-time attribute list (see e.g., 803) regarding cell phone usage from the telecom site 603, a real-time attribute list (see e.g., 804) containing Short Message Service (SMS) usage from an ISP 604, and a real time attribute list (see e.g., 802) containing bank account information relating to account purchases from a banking site 602. Once received, a module 1102 may be executed so as to generate or update an existing network map. FIGS. 5 and 18 are examples of a network maps that could be generated from such data. Once updated, a module 1104 may be executed to make a determination as too the likelihood that a member or members of a network might be interested in purchasing a particular good or service. The determination could be made in real time or near real time such that at the instant at which a member (e.g., 502 or 503) visits, for example, and e-commerce site 701 the member could be solicited to purchase goods or services based upon the calculations of, for example, modules 1101, 1102 and 1104.

In some embodiments, e-commerce site 701 may be only be supplied with real-time data for a fee from the various other members of the merchant network, and the manner in which this real-time data is evaluated may left entirely up to the e-commerce site 701. In still other embodiments, an application is run by the e-commerce site 701 that may implement the above described modules 1101-1104. This could be understood as a turn-key solution, where software implementing the module 1101-1104 is sold to a member of the merchant network. In still other embodiments, a service could be sold to non-members of the merchant network whereby global score data or attribute lists and mapping could be supplied for a fee to the non-member, where the non-member requests information relating to, for example, a normal actor such as normal actor 304 or a fraudster such as fraudster 102. This could be understood as a protection program provided to non-members or, even in some cases members of the merchant network.

### A Computer System

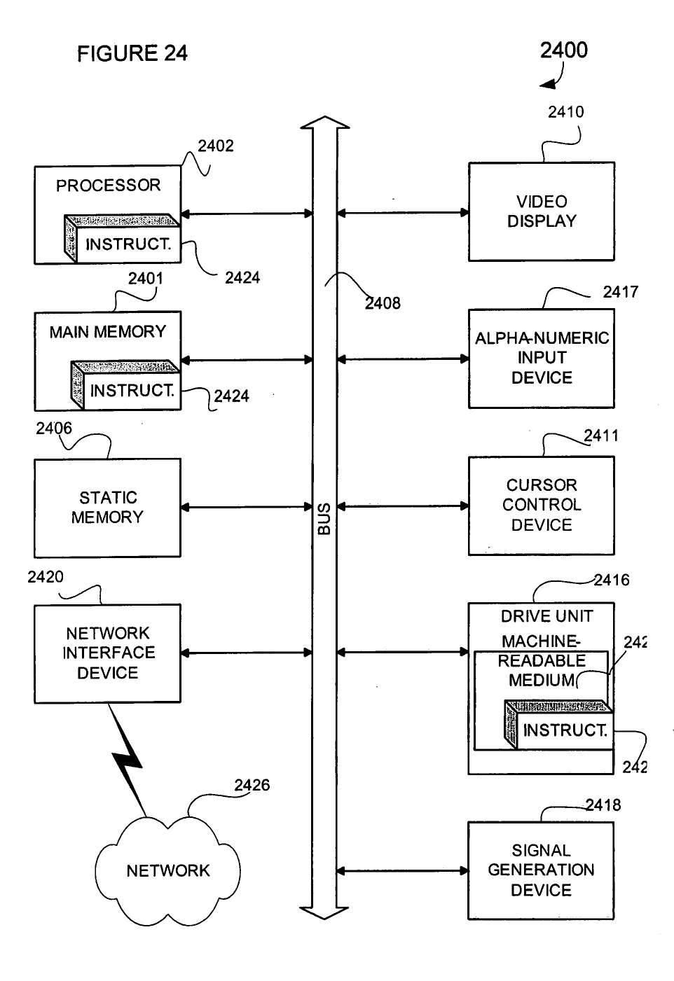

FIG. 24 shows a diagrammatic representation of a machine in the example form of a computer system 2400 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems which are linked (e.g., either by hardwired, wireless, or a combination of hardwired and wireless connections) through a network, both perform tasks. In a distributed system environment, program modules may be located in both local and remote memory-storage devices (see below).

The example computer system 2400 includes a processor 2402 (e.g., a Central Processing Unit (CPU), a Graphics Processing Unit (GPU) or both), a main memory 2401 and a static memory 2406, which communicate with each other via a bus 2408. The computer system 2400 may further include a video display unit 2410 (e.g., a Liquid Crystal Display (LCD) or a Cathode Ray Tube (CRT)). The computer system 2400 also includes an alphanumeric input device 2417 (e.g., a keyboard), a User Interface (UI) cursor controller 2411 (e.g., a mouse), a disc drive unit 2416, a signal generation device 2418 (e.g., a speaker) and a network interface device (e.g., a transmitter) 2420.

The disc drive unit 2416 includes a machine-readable medium 2422 on which is stored one or more sets of instructions and data structures (e.g., software) embodying or utilized by any one or more of the methodologies or functions described herein. The software may also reside, completely or at least partially, within the main memory 2401 and/or within the processor 2402 during execution thereof by the computer system 2400, the main memory 2401 and the processor 2402 also constituting machine-readable media.

The instructions 2421 may further be transmitted or received over a network 2426 via the network interface device 2420 utilizing any one of a number of well-known transfer protocols (e.g., HTTP, Session Initiation Protocol (SIP)).

While the removable physical storage medium 413 is shown in an example embodiment to be a single medium, the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies described herein. The term “machine-readable medium” shall accordingly be taken to include, but not be limited to, solid-state memories, optical and magnetic medium, and carrier wave signals.

In some embodiments, a system is illustrated as comprising a receiver residing on a server to receive data from one or more nodes that are apart of a merchant network, a calculator residing on the server to calculate a score based upon the data, a mapper residing on the server to map the score to an assessment score, and a alerter residing on a server to send an alert where a threshold value is exceed by the mapping of the score to the assessment score. In some cases, this alert may be by way of a signal sent to a computer system informing it of the existence of a fraudster or fraudsters' network. In still other embodiments, this alert may be sent to a computer system to advise the users of a system as to a marketing opportunity. This alert may be a screen prompt, email message, graph showing behavior over time or some other suitable alert. In some cases data is selected from the group of data consisting of global conduct scores and attribute lists. Further, the one or more nodes are selected from the group of nodes consisting of an e-commerce site, banking site, telecom site and ISP site. Additionally, the system may further include the calculator residing on the server to calculate the score using a composite system. Moreover, the system may further comprise the calculator residing on the server to calculate the score using a feed system. In addition, the system may further comprise a second calculator residing on a server to calculate an assessment score using an AI algorithm. Further, the system may further include a determiner residing on a server to determine the existence of a link between a first node and a second node in a network based upon the threshold value being exceed. Moreover, the system may further include a transmitter residing on the server to provide the data real time to the one or more nodes that are apart of the merchant network. Additionally, the system may further include a second transmitter residing on one or more of the nodes to transmit marketing materials to a member of a social network based upon the mapping of the score to an assessment score.

In some embodiments, a method is described as including receiving data from one or more nodes that are apart of a merchant network, calculating a score based upon the data, mapping the score to an assessment score, and alerting one or more nodes where a threshold value is exceed by the mapping of the score to the assessment score. In some cases, this alerting may be by way of a signal sent to a computer system informing it of the existence of a fraudster or fraudsters' network. In still other embodiments, this alert may be sent to a computer system to advise the users of a system as to a marketing opportunity. This alert may be a screen prompt, email message, graph showing behavior over time or some other suitable alert. Further, the data may be selected from the group of data consisting of global conduct scores and attribute lists. Additionally, the nodes may be selected from the group of nodes consisting of an e-commerce site, banking site, telecom site and ISP site. Moreover, the method may further include calculating the score using a composite method. In addition, the method may further include calculating the score using a feed method. The method may further include calculating an assessment score using an AI algorithm. Moreover, the method may further include determining the existence of a link between a first node and a second node in a network based upon the threshold value being exceed. In addition, the method may further include providing the data real time to the one or more nodes that are apart of the merchant network. The method may further include marketing to a member of a social network based upon the mapping of the score to an assessment score.

Some example embodiments may further include a computer-readable medium embodying instructions, the instructions including a first instruction set to receive data from one or more nodes that are apart of a merchant network, a second instruction set to calculate a score based upon the data, a third instruction set to map the score to an assessment score, and a fourth instruction set to alert where a threshold value is exceed by the mapping of the score to the assessment score. In some cases, this alert may be by way of a signal sent to a computer system informing it of the existence of a fraudster or fraudsters' network. In still other embodiments, this alert may be sent to a computer system to advise the users of a system as to a marketing opportunity. This alert may be a screen prompt, email message, graph showing behavior over time or some other suitable alert.

Moreover, some example embodiments may include an apparatus including mean for receiving data from one or more nodes that are apart of a merchant network, means for calculating a score based upon the data, means for mapping the score to an assessment score and means for alerting where a threshold value is exceed by the mapping of the score to the assessment score.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a receiver residing on a server to receive data from at least one node of a merchant network;
a calculator residing on the server to calculate a score based upon the data;
a mapper residing on the server to map the score to an assessment score; and
an alerter residing on the server to send an alert to a computer system where a threshold value is exceed by the mapping of the score to the assessment score.

2. The system of claim 1, wherein the data is selected from data consisting of global conduct scores and attributes lists.

3. The system of claim 1, wherein the at least one node is selected from the group of nodes consisting of an e-commerce site, a banking site, a telecom site and an Internet Service Provider (ISP) site.

4. The system of claim 1, wherein the calculator is to calculate the score using a composite system.

5. The system of claim 1, wherein the calculator is to calculate the score using a feed system.

6. The system of claim 1, further comprising a further calculator residing on the server to calculate an assessment score using an Artificial Intelligence (AI) algorithm.

7. The system of claim 1, further comprising a determiner residing on a server to determine the existence of a link between a first node and a second node based upon the threshold value being exceed.

8. The system of claim 1, further comprising a transmitter residing on the server to provide data in real time to at least one node of the merchant network.

9. The system of claim 1, further comprising a second transmitter residing on at least one of the nodes to transmit marketing materials to a member of a social network based upon a result based on the mapping of the score to an assessment score.

10. A method comprising:
receiving data from at least one node of a merchant network;
calculating a score based upon the data;
mapping the score to an assessment score; and
alerting the at least one node of the merchant network where a threshold value is exceeded by the mapping of the score to the assessment score.

11. The method of claim 10, wherein the data is selected from the group of data consisting of global conduct scores and attributes lists.

12. The method of claim 10, wherein at least one node of the merchant network is selected from the group of nodes consisting of an e-commerce site, banking site, telecom site and Internet Service Provider (ISP) site.

13. The method of claim 10, further comprising calculating the score using a composite method.

14. The method of claim 10, further comprising calculating the score using a feed method.

15. The method of claim 10, further comprising calculating an assessment score using an Artificial Intelligence (AI) algorithm.

16. The method of claim 10, further comprising determining the existence of a link between a first node and a second node in a network based upon the threshold value being exceed.

17. The method of claim 10, further comprising providing the data real time to one node of the merchant network.

18. The method of claim 10, further comprising marketing to a member of a social network based upon the mapping of the score to an assessment score.

19. A computer-readable medium embodying instructions, the instructions comprising:
a first instruction set to receive data from at least one node of a merchant network;
a second instruction set to calculate a score based upon the data;
a third instruction set to map the score to an assessment score; and
a fourth instruction set to alert where a threshold value is exceeded by the mapping of the score to the assessment score.

20. An apparatus comprising:
mean for receiving data from at least one node of a merchant network;
means for calculating a score based upon the data;
means for mapping the score to an assessment score; and
means for alerting a computer system where a threshold value is exceed by the mapping of the score to the assessment score.
